(19) United States
(12) Patent Application Publication
(10) Pub. No.: US 2025/0389625 A1
(43) Pub. Date: Dec. 25, 2025

(54) VEHICLE-MOUNTED DRAIN SEPARATOR, AND VEHICLE-MOUNTED EXHAUST GAS ANALYSIS DEVICE

(71) Applicant: HORIBA, LTD., Kyoto-shi, Kyoto (JP)

(72) Inventors: Miho SATO, Kyoto-shi, Kyoto (JP); Yoshihisa ONDA, Kyoto-shi, Kyoto (JP)

(73) Assignee: HORIBA, LTD., Kyoto-shi, Kyoto (JP)

(21) Appl. No.: 18/836,230

(22) PCT Filed: Mar. 31, 2023
(86) PCT No.: PCT/JP2023/013691

§ 371 Date: Apr. 11, 2025

(30) Foreign Application Priority Data
May 10, 2022 (JP) 2022-077592

(51) Int. Cl. G01N 1/22

(52) U.S. Cl. CPC G01N 1/2252; G01N 2001/2255

(57) ABSTRACT

There is provided a vehicle-mounted drain separator 100 that is used in a vehicle-mounted exhaust gas analysis device 200, and that includes an exhaust gas flow path EL through which flows exhaust gas, and a dilution gas flow path AL through which flows a gas that is taken in from the outside in order to dilute exhaust gas, and that merges with the exhaust gas flow path EL at a confluence point CP located at a downstream end portion. The vehicle-mounted drain separator 100 is formed in such a way that a heat exchange is generated at least on an upstream side of the confluence point CP between the exhaust gas flowing through the exhaust gas flow path EL and the gas flowing through the dilution gas flow path AL.

### TECHNICAL FIELD

The present invention relates to a drain separator that is used in a vehicle-mounted type of exhaust gas analysis device.

### TECHNICAL BACKGROUND

Conventionally, a vehicle-mounted type of exhaust gas analysis device that analyzes concentrations of components in exhaust gas emitted from a vehicle is used in order to perform an RDE (Real Driving Emission) test or the like. As is shown in FIG. 10, this type of exhaust gas analysis device is provided with an analyzer X into which is introduced exhaust gas that has been kept at 100° C. or more in order to prevent moisture therein from condensing, and that then analyzes the introduced exhaust gas, a drain separator 100A that condenses and then removes the moisture from the exhaust gas that has passed through the analyzer X, and an exhaust pump P that is provided on a downstream side of the drain separator 100A. In this structure, air for performing dilution is introduced into the exhaust gas that has passed through the drain separator 100A, and the resulting diluted exhaust gas is discharged to the outside of the vehicle via the exhaust pump P.

However, if it is not possible for the moisture to be sufficiently condensed in the drain separator, then condensation is created within the pipes through which the exhaust gas is circulating. The area of the flow path may then become decreased due to condensation moisture covering the internal surfaces of the pipes, and this may cause an increase in pressure. Because electrical power is limited in an exhaust gas analysis device that is mounted in a vehicle, the discharge pressure of the exhaust pump is not very high, so that if a pressure increase is generated within the pipes, there is a possibility that the circulation of the exhaust gas, as well as the analysis thereof, will be hindered.

In order to prevent this type of problem from occurring, it is necessary to improve the performance when condensing moisture in the drain separator. As is shown, for example, in Patent Document 1, in an exhaust gas analysis device that is used in tests performed inside a factory on a chassis dynamometer, instrument air that is used to drive the control valves and the like inside the factory is circulated around the drain separator so as to promote a discharge of heat from the exhaust gas, and so as to thereby improve the moisture removal capability of the drain separator.

However, in a vehicle-mounted type of exhaust gas analysis device, it is not possible in the first place for instrument air to be used. Moreover, in a case in which the overall weight of the exhaust gas analysis device will increasing and there is a possibility that this will impose a heavy load on the RDE test, it is difficult to tolerate mounting a separate supply tank for the cooling air in the vehicle that will be needed simply to cool the exhaust gas.

### Documents of the Prior Art

### Patent Documents

[Patent Document 1] Japanese Unexamined Patent Application (JP-A) No. H10-197422

### DISCLOSURE OF THE INVENTION

### Problems to be Solved by the Invention

The present invention was conceived in view of the above-described problems, and it is an object thereof to provide a vehicle-mounted drain separator having an improved performance when removing moisture from exhaust gas without the power consumption being increased compared to the conventional technology, and to also provide an exhaust gas analysis device that utilizes this vehicle-mounted drain separator.

### Means for Solving the Problem

In other words, a vehicle-mounted drain separator according to the present invention is a vehicle-mounted drain separator that is used in a vehicle-mounted exhaust gas analysis device, and that includes an exhaust gas flow path through which flows exhaust gas, and a dilution gas flow path through which flows a gas that is used to dilute the exhaust gas, and that merges with the exhaust gas flow path at a confluence point located at a downstream end portion, and that is characterized in being formed in such a way that a heat exchange is generated at least on an upstream side of the confluence point between the exhaust gas flowing through the exhaust gas flow path and the gas flowing through the dilution gas flow path.

If this type of structure is employed, then by supplying air, which has been used conventionally, for example, in a vehicle-mounted type of exhaust gas analysis device, and is acquired from inside a housing of the exhaust gas analysis device or from outside the housing on the exhaust gas device side, to the dilution gas flow path in order to dilute the exhaust gas, it is possible to sufficiently discharge heat from exhaust gas inside the drain separator, and to also dilute the exhaust gas while sufficiently condensing moisture in the exhaust gas. As a result, it is possible to prevent condensation from being generated on the downstream side of the drain separator, and to prevent the circulation of the exhaust gas, as well as the analysis thereof, from being obstructed. Moreover, because the moisture removal performance in the drain separator is improved simply by altering the placements of the exhaust gas flow path and the dilution gas flow path in comparison with a conventional structure, there is no increase in the level of power consumption. Alternatively, even in a case in which an air tank is mounted in a vehicle, by supplying air for dilution to the dilution gas flow path, it is possible to not only dilute the exhaust gas, but to also cool the exhaust gas using the air before the air is used for dilution. In other words, even if there is a possibility that the overall weight of the exhaust gas analysis device will increase, because the exhaust gas analysis device is able to perform two functions, namely, both the dilution and the cooling of the exhaust gas, this weight increase can be easily tolerated.

In order to ensure that the majority of condensation moisture generated on the downstream side of the exhaust gas flow path is accumulated so that water droplets do not flow onto the downstream side of the drain separator, it is also possible for the exhaust gas flow path to include a first exhaust gas heat discharge flow path into which exhaust gas is introduced from an exhaust gas intake port, and a second exhaust gas heat discharge flow path that is provided on a downstream side of the first exhaust gas heat discharge flow path, and merges with the dilution gas flow path at the confluence point, and for a condensation moisture accumulation portion in which moisture that has been condensed from the exhaust gas is accumulated to be provided on the second exhaust gas heat discharge flow path.

In order to increase the length of time that a heat exchange occurs between the exhaust gas flowing through the first exhaust gas heat discharge flow path and the dilution gas flowing through the dilution gas flow path, and to thereby increase the quantity of heat discharge from the exhaust gas, it is also possible for a flow path area of the first exhaust gas heat discharge flow path to be formed so as to be greater than an aperture area of the exhaust gas intake port. Moreover, because the flow path area is increased in the first exhaust gas heat discharge flow path in this way, even if condensation is generated in the first exhaust gas heat discharge flow path, it is difficult for any sizable loss of pressure to occur, and it is also difficult for the flow of exhaust gas and the analysis thereof to be hindered.

In order to enable heat to be sufficiently discharged from exhaust gas on the second exhaust gas heat discharge flow path even in a state in which a temperature gradient between the exhaust gas and the dilution gas has been made smaller by the heat discharge from the exhaust gas on the first exhaust gas heat discharge flow path, and to thereby enable sufficient condensation to occur on the second exhaust gas heat discharge flow path, it is also possible for a flow path area of the second exhaust gas heat discharge flow path to be formed so as to be greater than the flow path area of the first exhaust gas heat discharge flow path. If this type of structure is employed, then because it is possible to further reduce the speed of the flow of exhaust gas in the second exhaust gas heat discharge flow path, and to lengthen the accumulation time, heat can be sufficiently discharged from the exhaust gas and the moisture therein sufficiently condensed.

In order to enable moisture to be condensed even more easily from the exhaust gas, it is also possible for there to be further provided heat absorption plate that is disposed on either the first exhaust gas heat discharge flow path or the second exhaust gas heat discharge flow path so as to obstruct the flow direction of the exhaust gas, and in which at least one exhaust gas circulation hole is formed, and for the heat absorption plate to be formed so as to transfer heat absorbed from the exhaust gas to a gas flowing through the dilution gas flow path. If this type of structure is employed, then moisture contained in the exhaust gas can be removed as water droplets on the surface of the heat absorption plate, and these removed water droplets can be easily collected.

An example of a specific structure that is used to enable heat from the exhaust gas that is flowing through the exhaust gas flow path to be more easily absorbed by the gas flowing through the dilution gas flow path is a structure in which the dilution gas flow path is formed as an internal flow path inside a flow path formation block, and in which the heat absorption plate is disposed so as to be in contact with the flow path absorption block.

In order to enable heat to be exchanged directly between the first exhaust gas heat discharge flow path and the dilution gas flow path without being transmitted through a heat absorption plate or the like, it is also possible for the first exhaust gas heat discharge flow path to be formed as an internal flow path inside the flow path formation block together with the dilution gas flow path.

For example, in order to enable condensation moisture that has been condensed in the second exhaust gas heat discharge flow path to be efficiently collected using the actual weight of the moisture itself, it is also possible for the condensation moisture accumulation portion to be disposed in a lower portion of the second exhaust gas heat discharge flow path.

In the limited space inside a vehicle, in order to lengthen the overall length where heat exchange occurs between the exhaust gas flow path and the dilution gas flow path, and to ensure that sufficient heat is captured from the exhaust gas, and to further improve the moisture removal performance, it is also possible for the first exhaust gas heat discharge flow path and the second exhaust gas heat discharge flow path to be disposed so as to sandwich the dilution gas flow path between them.

In order to lengthen even further the distance over which heat exchange occurs between the exhaust gas flowing through the exhaust gas flow path and the gas flowing through the dilution gas flow path, while also enabling the drain separator itself to be made more compact, it is also possible for a flow direction of the exhaust gas flow path or a flow direction of the dilution gas flow path to be formed so as to turn back on itself at least once.

In order to ensure that a heat exchange occurs between the exhaust gas flowing through the exhaust gas flow path and the gas flowing through the dilution gas flow path via a simple structure, it is also possible for the exhaust gas flow path and the dilution gas flow path to be disposed in close proximity to each other. Moreover, in a case in which moisture is sufficiently condensed from the exhaust gas on the upstream side of the exhaust gas flow path, then it is also possible for the condensation moisture accumulation portion to only be provided on the upstream side of this exhaust gas flow path.

If a vehicle-mounted exhaust gas analysis device is employed that is provided with the vehicle-mounted drain separator according to the present invention, and an analyzer that analyzes exhaust gas, and that is formed so that exhaust gas that has passed through the analyzer is introduced into the drain separator, then because moisture can be removed from exhaust gas after an analysis thereof has been completed without the power consumption being increased, it is possible to prevent, for example, an increase in pressure inside the pipes being generated by condensation in downstream portions from the drain separator and thereby causing a problem to occur in the circulation of the exhaust gas. Because of this, it is possible to guarantee that an accurate analysis will be performed. Moreover, because it is difficult for the pressure inside the pipes to increase, it is possible, for example, for a satisfactory analysis to be performed even if an exhaust pump having a low discharge pressure is used.

If a structure is employed in which a diluted exhaust gas flow path through which flows exhaust gas that has been diluted by dilution gas is provided on a downstream side of the confluence point between the exhaust gas flow path and the dilution gas flow path, and in which an exhaust gas pump is provided on the diluted exhaust gas flow path, then both the exhaust gas and the dilution gas can be circulated using a single exhaust gas pump, and not only can the structure of the device as a whole be simplified, but it can also be made more compact.

### Effects of the Invention

In this way, if the vehicle-mounted drain separator according to the present invention is employed, then by using air for dilution that, conventionally, has only been used to dilute the exhaust gas to also discharge heat from the exhaust gas, it is possible to satisfactorily remove moisture contained in exhaust gas. Moreover, because a heat exchange is generated between the exhaust gas and the air due, for example, to the placements of each of the flow paths, it is possible to improve the performance when removing moisture from exhaust gas compared to the conventional technology while also preventing any new power consumption from occurring.

### BRIEF DESCRIPTION OF THE DRAWINGS

FIG. 1 is a schematic view showing a vehicle-mounted exhaust gas analysis device of a first embodiment of the present invention.

FIG. 2 is a schematic view showing a structural outline of the vehicle-mounted exhaust gas analysis device of the first embodiment.

FIG. 3 is a schematic view showing an outline of the respective flow path structures of a drain separator of the first embodiment.

FIG. 4 is a schematic perspective view of the drain separator of the first embodiment.

FIG. 5 is a schematic perspective view showing an example of a heat absorption plate of the drain separator of the first embodiment.

FIG. 6 is a schematic cross-sectional view showing a first exhaust gas heat discharge flow path within a flow path formation block of the first embodiment.

FIG. 7 is a schematic cross-sectional view showing a dilution gas flow path within the flow path formation block of the first embodiment.

FIG. 8 is a schematic cross-sectional view showing a second exhaust gas heat discharge flow path of the first embodiment.

FIG. 9 is a schematic view showing an outline of the respective flow path structures of a drain separator of a second embodiment.

FIG. 10 is a schematic view showing a structure of a conventional vehicle-mounted exhaust gas analysis device.

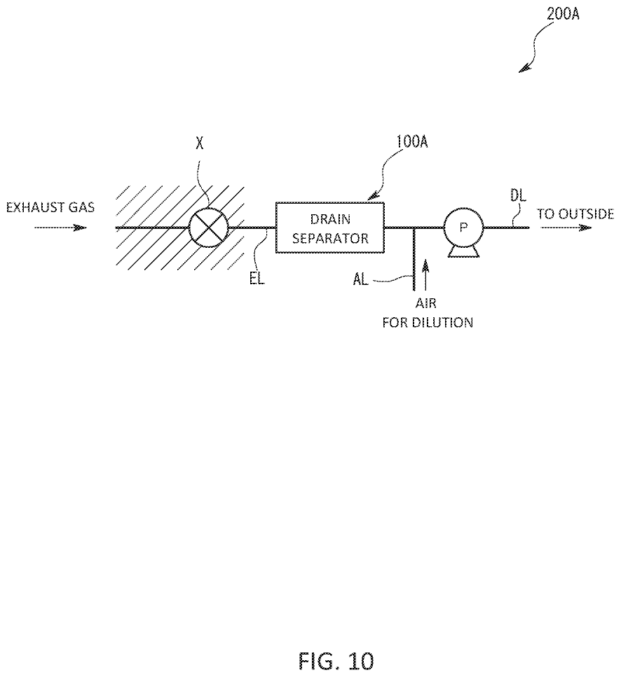

### BEST EMBODIMENTS FOR IMPLEMENTING THE INVENTION

Hereinafter, a vehicle-mounted exhaust gas analysis device 200 and drain separator 100 according to a first embodiment of the present invention will be described with reference to the drawings.

The vehicle-mounted exhaust gas analysis device 200 of the present embodiment is mounted, for example, in an automobile or the like, and measures the component concentrations of exhaust gas emitted from this vehicle. Note that the vehicle-mounted exhaust gas analysis device 200 is used to perform a real driving emission (RDE) test.

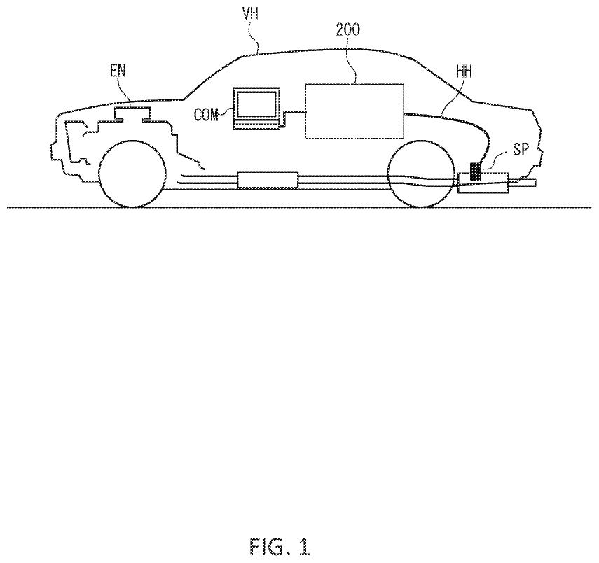

As is shown in FIG. 1, this vehicle-mounted exhaust gas analysis device 200 measures the component concentrations of exhaust gas collected by an exhaust gas collection mechanism such as a sampling pipe SP or the like that collects either all of, or a portion of the exhaust gas emitted from an exhaust pipe that is connected to an engine EN of the vehicle. The exhaust gas collected by the sampling pipe SP is heated to a predetermined temperature by a heating pipe HH, or alternatively the temperature thereof is maintained at a predetermined temperature by the heating pipe HH, and is then introduced into the vehicle-mounted exhaust gas analysis device 200. The predetermined temperature is set, for example, to 100° C. or higher so that any moisture in the exhaust gas is not condensed.

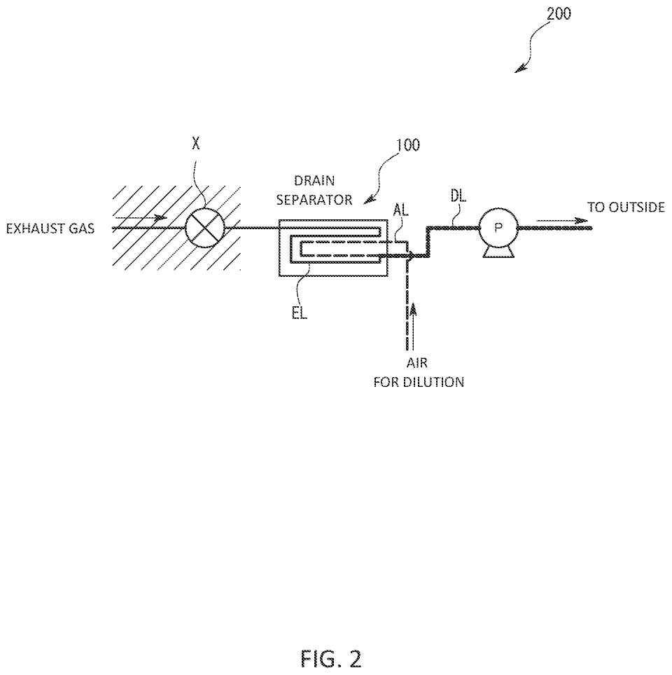

More specifically, as is shown in FIG. 2, the vehicle-mounted exhaust gas analysis device 200 is provided with an analyzer X into which exhaust gas that has passed through the heating pipe HH is introduced, and in which various components of the exhaust gas are analyzed, the drain separator 100 into which exhaust gas that has passed through the analyzer X is introduced, and in which moisture is separated from the exhaust gas, and an exhaust pump P that is disposed on a downstream side of the drain separator 100. In other words, a continuous flow path is formed from a connecting port where the heating pipe HH is connected to the vehicle-mounted exhaust gas analysis device 200 to a discharge port on the downstream side of the exhaust pump P, and the analyzer X, the drain separator 100, and the exhaust pump P are disposed in this sequence from the upstream side on this flow path. Each of these portions is described below in detail.

The analyzer X analyzes measurement target components such as, for example, carbon monoxide (CO), carbon dioxide (CO₂), nitrogen oxides (NOx), methane (CH₄), total hydrocarbons (THC), ammonia (NH₃), formaldehyde (HCHO), particulate matter (PM), and solid particles (PN) and the like. In the present embodiment, the analyzer X is a QCL-IR spectrometer that uses quantum cascade laser (QCL) spectroscopy, however, it is also possible for the analyzer X to be an analyzer that uses another gas detection method such as an NDIR sensor that uses nondispersive infrared (NDIR) absorption, an FTIR sensor that uses Fourier transform infrared (FTIR) spectroscopy, a CLD detector that uses chemiluminescence detection (CLD), or an FID detector that uses flame ionization detection (FID). In addition, a nondispersive ultraviolet absorption (NDUV) method, an O₂ measurement method performed using electrochemical cells, an NOx, O₂, NH₃ measurement method performed using zirconia sensors, a PM measurement method performed using DCS, and a PN measurement method performed using CPC may also be used.

The QCL-IR spectrometer of the present embodiment is provided with a quantum cascade laser (not shown in the drawings) that irradiates laser light onto a flow path through which the exhaust gas is flowing, and with a detector (not shown in the drawings) that detects laser light that has passed through the exhaust gas. The oscillation wavelength of this quantum cascade laser is able to be modulated via the current (or voltage) that is applied thereto, and a semiconductor laser that employs intersubband transition using a multiple quantum well structure is employed here as the quantum cascade laser. For example, a rise in temperature is generated when current pulses are applied to the quantum cascade laser. This causes the oscillation wavelength to change and thereby causes laser light of a predetermined wavelength range to be emitted. In the present embodiment, an element whose oscillation center wavelength has been adjusted such that an absorption peak of each target gas component falls within this oscillation wavelength is used, and laser light is emitted repeatedly at predetermined intervals in a wavelength range between, for example, approximately 4 μm and approximately 20 μm. The detector utilizes a quantum photoelectric element and, in the present embodiment, INAsSb is used as the detection element. Note that the detection element is not limited to this, and it is also possible, for example, for HgCdTe, InGaAs, or PbSe or the like to be used instead.

Analysis data obtained using these analyzers X is output to an information processing unit COM shown in FIG. 1, and processing of this analysis data, as well as the recording or displaying thereof are performed by this information processing unit COM. Moreover, it is also possible for the above-described plurality of analyzers to be provided as mutually separate devices. The information processing unit COM is either a dedicated or a general purpose computer having a CPU, internal memory, an A/D converter, a D/A converter, and various input/output devices and the like. The information processing unit COM acquires not only analysis data from the analyzers X, but also data from various other sensor groups which it processes, and then records or displays.

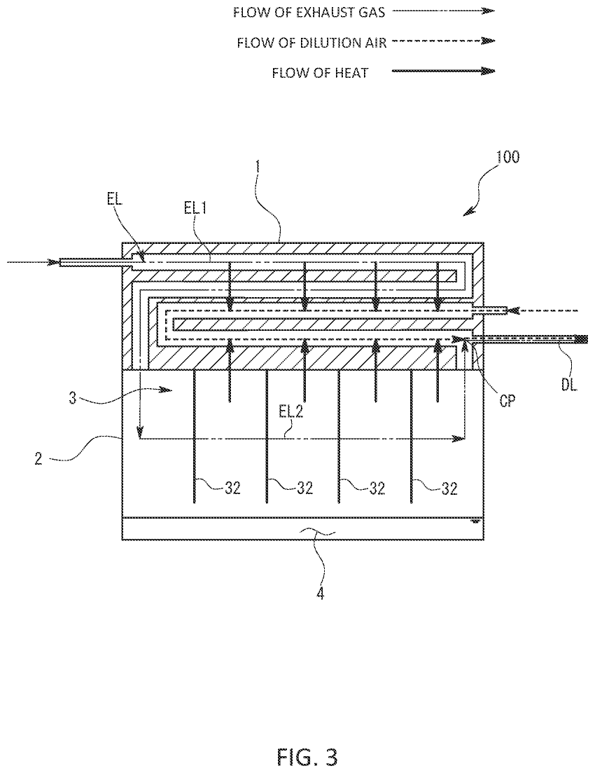

Next, an outline of the drain separator 100 as well as of various devices relating thereto will be described with reference made to the schematic diagrams shown in FIG. 2 and FIG. 3.

As is shown in FIG. 2 and FIG. 3, the drain separator 100 of the present embodiment is provided not only with an exhaust gas flow path EL through which exhaust gas flows, but also with a dilution gas flow path AL through which air flows before this air has been used to dilute the exhaust gas. Moreover, a structure is employed in which the exhaust gas that has not yet been diluted flowing through the exhaust gas flow path EL is cooled using the air flowing through the dilution gas flow path AL. More specifically, the exhaust gas flow path EL and the dilution gas flow path AL are disposed in close proximity to each other inside the drain separator 100, so that a heat conduction structure is formed that enables heat to move between the gases flowing through the respective flow paths. In other words, the drain separator 100 of the present embodiment is formed in such a way that a heat exchange is generated between the undiluted exhaust gas and the air that has not yet been mixed with the exhaust gas that are flowing through their respective flow paths. In the present embodiment, because the outer dimensions of the exhaust gas analysis device 200 are 350×550×255 mm, the exhaust gas flow path EL and the dilution gas flow path AL may be disposed at a distance of, for example, not more than 550 mm from each other. Note that the exhaust gas flow path EL and the dilution gas flow path AL may also be disposed at a distance of 350 mm, or at a distance of 255 mm from each other, or may even be disposed so as to be almost in contact with each other.

The exhaust gas flow path EL in the drain separator 100 is formed by the flow path portion from an exhaust gas intake port EP where exhaust gas that has passed through the analyzer X is introduced, to a confluence point CP where the exhaust gas flow path EL merges with the dilution gas flow path AL.

On the other hand, the dilution gas flow path AL is formed such that a base end side thereof is open to the air so as to enable air to be taken into the dilution gas path AL from outside the drain separator 100 or from outside the gas analysis device 200. In the present embodiment a structure is employed in which a base end of the dilution gas flow path AL opens inside a housing (not shown in the drawings) that internally houses the drain separator 100. The confluence point CP where the dilution gas flow path AL merges with the exhaust gas flow path EL is provided at a downstream end portion of the dilution gas flow path AL. The exhaust gas is diluted as a result of the exhaust gas mixing with air at this confluence point CP.

A diluted exhaust gas flow path DL through which flows exhaust gas that has been diluted by air is connected to the downstream side of the merging portion CP, and the exhaust pump P is provided on this diluted exhaust gas flow path DL. In other words, a structure is employed in which, using the single exhaust pump P, both exhaust gas and air are suctioned and made to flow through the exhaust gas flow path EL and the dilution gas flow path AL respectively.

In the present embodiment, the exhaust gas flow path EL is formed by a first exhaust gas heat discharge flow path EL1 that forms an upstream-side portion of the exhaust gas flow path EL, and a second exhaust gas heat discharge flow path EL2 that forms a downstream-side portion of the exhaust gas flow path EL.

The first exhaust gas heat discharge flow path EL1 is connected to the exhaust gas intake port EP and, as is shown in FIG. 3, is formed in an upper-portion side of the drain separator 100. Here, the first exhaust gas heat discharge flow path EL1 is formed as an internal flow path inside a single flow path formation block 1 together with the dilution gas flow path AL. In other words, the first exhaust gas heat discharge flow path EL1 and the dilution air flow path are adjacent to each other via a thermally conductive metal that forms the flow path formation block 1, and a heat exchange is able to occur between the exhaust gas and the air flowing through the respective flow paths. More specifically, because the exhaust gas is heated, for example, to 100 degrees or greater until it is introduced into the analyzer X, the exhaust gas is at a higher temperature than the air taken in from the outside which is, for example, at approximately a normal air temperature. Accordingly, a transfer of heat from the exhaust gas to the air occurs, and the exhaust gas flowing through the first exhaust gas heat discharge flow path EL1 continuously discharges heat to the air flowing through the dilution gas flow path AL.

In contrast, the second exhaust gas heat discharge flow path EL2 is provided on the downstream side of the first exhaust gas heat discharge flow path EL1, and merges with the dilution gas flow path AL at the confluence point CP. More specifically, the second exhaust gas heat discharge flow path EL2 is formed in a lower-side portion of the drain separator 100, and is formed by a flow path that follows a meandering course inside a housing 2, and by a portion located inside the flow path formation block 1. Moreover, as is shown in FIG. 3, the first exhaust gas heat discharge flow path EL1 and the second exhaust gas heat discharge flow path EL2 are disposed so as to sandwich the dilution gas flow path AL from above and below on the upstream side of the confluence point CP.

Moisture in the exhaust gas that has condensed inside the second exhaust gas heat discharge flow path EL2 is accumulated in a condensation moisture accumulation portion 4 that is provided on the lower side of the second exhaust gas heat discharge flow path EL2. Here, the condensation moisture accumulation portion 4 is a hollow cavity provided in the drain separator 100, and condensation moisture accumulated in the condensation moisture accumulation portion 4 is discharged by removing a stopper provided in a bottom surface of the drain separator 100. In other words, during testing, condensation moisture continuously accumulates in the condensation moisture accumulation portion 4, and when maintenance is performed after testing has ended, the stopper is removed and processing of the accumulated condensation moisture is performed.

Furthermore, a heat transfer mechanism 3 that is disposed so as to be in contact with a lower surface side of the flow path formation block 1 is provided in the second exhaust gas heat discharge flow path EL2. Accordingly, the heat from the exhaust gas flowing through the second exhaust gas heat discharge flow path EL2 is transferred via the heat transfer mechanism 3 to the air flowing through the dilution gas flow path AL inside the flow path formation block 1. In this way, heat exchanges are performed at least twice in the exhaust gas flow path EL above and below the dilution gas flow path AL.

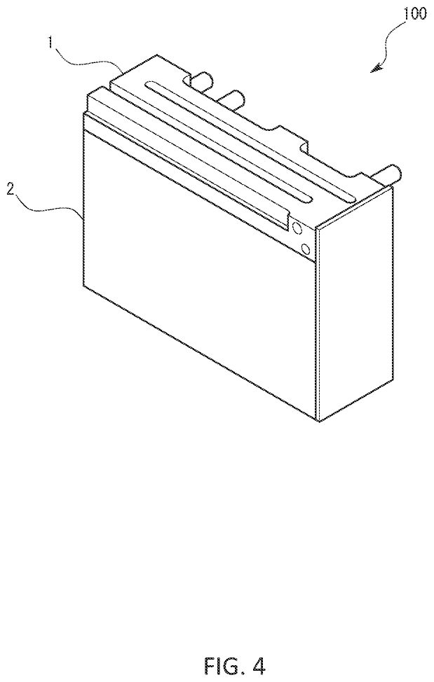

Next, the specific structure of the drain separator 100 will be described with reference made to FIG. 4 through FIG. 8.

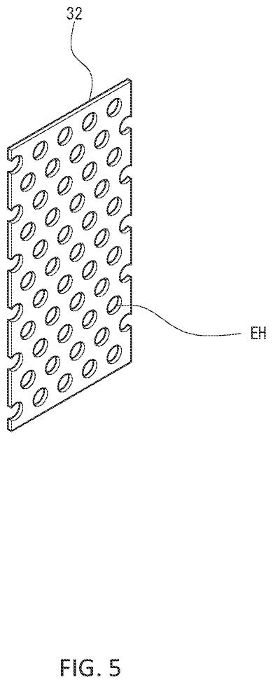

As is shown in FIG. 4, the drain separator 100 is formed substantially in a rectangular parallelepiped shape. As is shown in FIG. 5, the drain separator 100 is provided with the flow path formation block 1 that forms an upper end-surface portion thereof, the housing 2 that is welded to a lower side of the flow path formation block 1, and the heat transfer mechanism 3 that is located inside the housing 2 and is in contact with the lower surface side of the flow path formation block 1.

The first exhaust gas heat discharge flow path EL1 and the dilution gas flow path AL are formed as internal flow paths inside the flow path formation block 1, while the second exhaust gas heat discharge flow path EL2 is formed by the heat transfer mechanism 3 inside the housing 2 which has been sealed by welding.

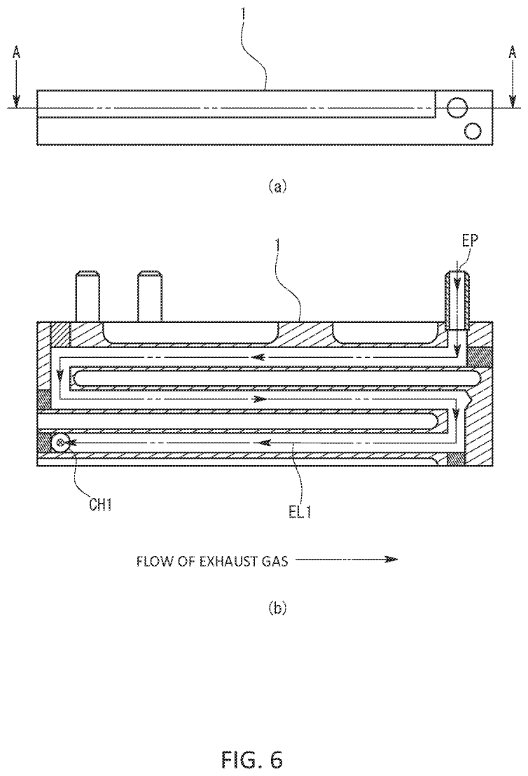

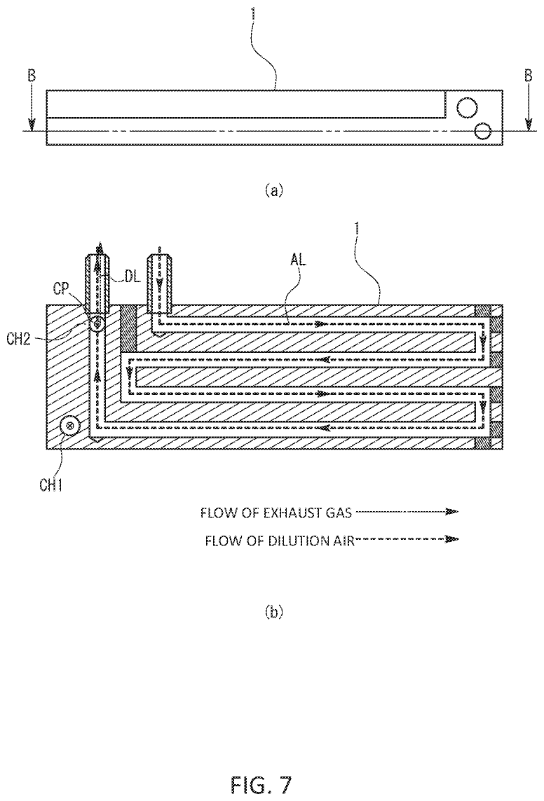

The flow path formation block 1 is formed substantially in a plate shape and, as is shown in FIG. 6 and FIG. 7, mutually independent internal flow paths are formed inside the flow path formation block 1 in two layers in the thickness direction thereof. These internal flow paths may be formed, for example, by performing drilling processing or the like, and then sealing off the unnecessary portions. Note that it is also possible to form the flow path formation block 1 using, for example, metal 3D printing technology or the like instead of by performing mechanical processing. As is shown in FIG. 6 (b), which is a cross-sectional view taken along a line A-A in FIG. 6 (a), the first exhaust gas heat discharge flow path EL1 is formed as an internal flow path that turns back and forth on itself on an upper layer side of the flow path formation block 1. Exhaust gas that has passed through the analyzer X is introduced into the interior of the flow path formation block 1 via an exhaust gas intake port EP located on an upper-right side of FIG. 6 (b). Exhaust gas that has traveled back and forth inside the flow path formation block 1 then flows into a space formed by the housing 2 through a first communication hole CH1 that extends in the thickness direction of the flow path formation block 1 and opens onto the lower-surface side of the flow path formation block 1.

As is shown in FIG. 7 (b), which is a cross-sectional view taken along a line B-B in FIG. 7 (a), the dilution gas flow path AL is formed as an internal flow path that turns back and forth on itself on a lower layer side of the flow path formation block 1. Air taken in from the outside atmosphere is introduced into the interior of the flow path formation block 1 via an air intake port located on an upper-left side of FIG. 7 (b). Air that has traveled back and forth inside the flow path formation block 1 then reaches the downstream end portion of the dilution flow path AL which is located on the upper-left side in FIG. 7 (b). A second communication hole CH2 that extends in the thickness direction of the flow path formation block 1 and opens in the lower surface of the flow path formation block 1 is formed in this downstream end portion. Exhaust gas passes through this second communication hole CH2 from the second exhaust gas heat discharge flow path EL2 inside the housing 2 and merges with the dilution gas flow path AL. In other words, the portion where the second communication hole CH2 is formed is the confluence point CP between the exhaust gas flow path EL and the dilution gas flow path AL. The exhaust gas and air are mixed together in this portion, and subsequently flow to the exhaust pump P in the form of diluted exhaust gas.

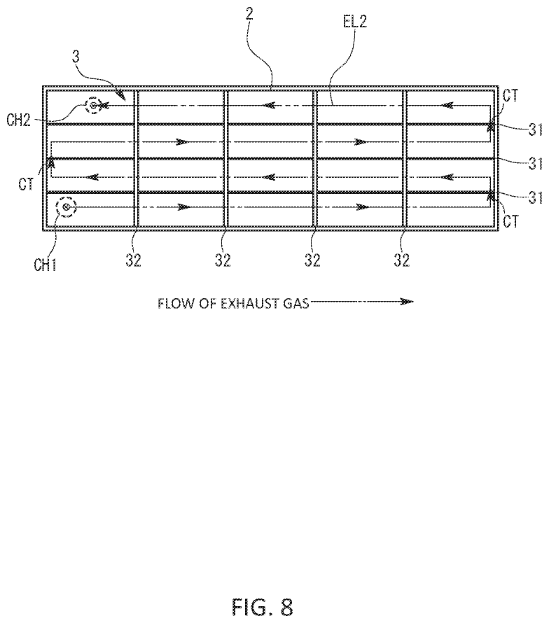

FIG. 8 is a view as seen from an upper-surface side showing the substantially rectangular parallelepiped-shaped housing 2 in the drain separator 100, and the heat transfer mechanism 3 that is housed in the housing 2. The second exhaust gas heat discharge flow path EL2 that that turns back and forth on itself in the lower-side portion of the drain separator 100 is formed by the housing 2 and the heat transfer mechanism 3. As is shown in FIG. 5 and FIG. 8, the heat transfer mechanism 3 is provided with three partitioning plates 31 that extend in the longitudinal direction of the housing 2, which is also the flow direction of the second exhaust gas heat discharge flow path EL2, and with four heat absorption plates 32 that are disposed so as to be perpendicular to the partitioning plates 31 and so as to block the flow direction of the second exhaust gas heat discharge flow path EL2.

A cutout CT is formed in a central portion of one end portion in the longitudinal direction of the partitioning plates so that gaps are formed between the partitioning plates and the housing 2. Exhaust gas is able to circulate via these gaps in an up-down direction as seen in FIG. 8. In the present embodiment, because the orientations of the partitioning plates are alternated sequentially relative to each other, the second exhaust gas heat discharge flow path EL2 is formed so as to turn back on itself.

As is shown in FIG. 5, a plurality of exhaust gas circulation holes EH are provided so as to penetrate the heat absorption plates 32 in the thickness direction thereof. The diameter of these exhaust gas circulation holes EH may be set, for example, to approximately the same as the diameter of the internal flow path inside the flow path formation block 1. Because the heat absorption plates 32 are disposed so as to block the flow direction of the second exhaust gas heat discharge flow path EL2, a portion of the exhaust gas becomes blocked by a surface plate portion of the heat absorption plates 32 and ends up flowing through the exhaust gas circulation holes EH in a meandering fashion from the lower-left side of FIG. 8 towards the upper-left side thereof. At this time, heat is transferred to the heat absorption plates 32 because of the heat transfer between heat absorption plates 32 and the exhaust gas, and ultimately, heat is transferred to the air in the dilution gas flow path AL inside the flow path formation block 1. Consequently, as a result of the exhaust gas flowing through the second exhaust gas heat discharge flow path EL2, heat is released from the exhaust gas so that the temperature of the exhaust gas drops below the dew point temperature, and condensation moisture becomes condensed on the surface of the heat absorption plates 32. The condensation moisture adhering to the surface of the heat absorption plates 32 trickles downwards due to its own weight, and ultimately accumulates in the condensation moisture accumulation portion 4 inside the housing 2.

According to the vehicle-mounted drain separator 100 of the first embodiment that is formed in the above-described manner, a heat exchange can be generated between the exhaust gas flowing through the exhaust gas flow path EL and the dilution gas flowing through the dilution gas flow path AL so that, in comparison with a conventional structure, the cooling performance when cooling exhaust gas is improved without this causing any marked increase in power consumption, and moisture in the exhaust gas can be satisfactorily condensed and removed.

Moreover, because both the exhaust gas flow path EL and the dilution gas flow path AL are both formed turning back on themselves inside the drain separator 100, the drain separator 100 itself can be made more compact while, at the same time, the distance over which heat is exchanged between the exhaust gas and the air can be lengthened. Because of this, the quantity of heat transferred from the exhaust gas to the air can be increased even further, and the moisture removal performance when removing moisture from the exhaust gas can be improved.

Moreover, because the heat absorption plates 32 in which the plurality of exhaust gas circulation holes EL are formed are provided on the second exhaust gas heat discharge flow path EL2 so as to block the flow direction of the exhaust gas, condensation moisture is made to adhere to the surface of the heat absorption plates 32, and can be efficiently collected in the condensation moisture accumulation portion 4 on the lower side of the drain separator 100 without any further processing being required.

In addition, because the flow path area of the second exhaust gas heat discharge flow path EL2 that is provided on the downstream side is formed larger than the flow path area of the first exhaust gas heat discharge flow path EL1, the flow velocity of the exhaust gas flowing through the second exhaust gas heat discharge flow path EL2 where the condensation accumulation portion 4 is located is reduced, so that the accumulation time is lengthened, and the probability that a greater quantity of moisture will be collected by the heat absorption plates 32 can be increased.

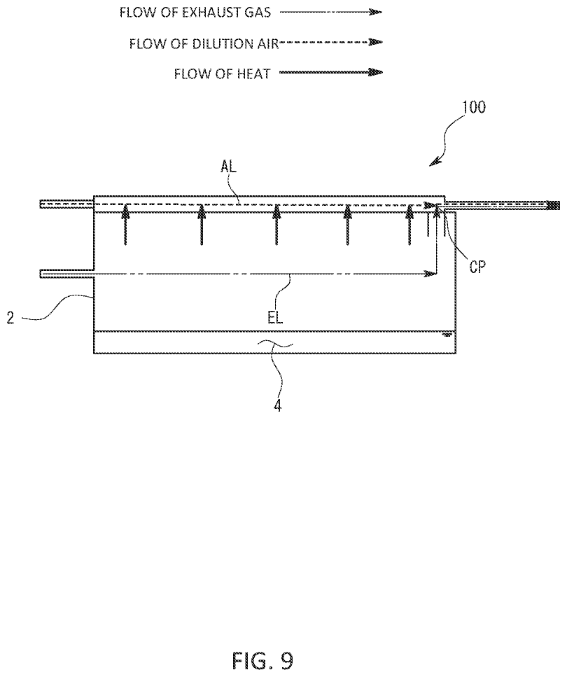

Next, a vehicle-mounted drain separator 100 according to a second embodiment of the present invention will be described with reference to FIG. 9.

The vehicle-mounted drain separator 100 of the second embodiment has a simplified structure compared to that of the first embodiment. More specifically, the dilution gas flow path AL and the exhaust gas flow path EL are provided in close proximity to each other, and in parallel with each other on the upstream side of the confluence point CP between the dilution gas flow path AL and the exhaust gas flow path EL. In other words, the housing 2 that forms the exhaust gas flow path EL and the condensation moisture accumulation portion 4, and the pipe forming the dilution gas flow path AL for that housing 2 are provided so as to be in contact with each other. Note that in the second embodiment, the heat absorption plates 32 of the first embodiment are not provided in the exhaust gas flow path EL, and no blocking component is provided in the flow direction of the exhaust gas.

In this type of simple structure as well, it is possible to capture heat from exhaust gas using air that has not yet been used to dilute exhaust gas, and to lower the temperature thereof so as to cause moisture to become condensed within the exhaust gas flow path EL. Moreover, because it is unnecessary to construct a complex flow path, manufacturability of the drain separator 100 can be improved.

Additional embodiments will now be described.

The structure used to generate a heat exchange between exhaust gas flowing through the exhaust gas flow path and air flowing through the dilution gas flow path is not limited to the structures illustrated in the first and second embodiments. For example, it is also possible for a first metal tube that forms the exhaust gas flow path and a second metal tube that forms the dilution gas flow path to be provided at a distance from each other, and for these two tubes to be connected together using a heat transfer component so that heat is able to travel from the exhaust gas to the air.

In the first embodiment, heat absorption plates are not provided in the first exhaust gas heat discharge flow path, however, it is also possible for heat absorption plates to be provided in the first exhaust gas heat discharge flow path. Moreover, it is not essential that the first exhaust gas heat discharge flow path and the dilution gas flow path be formed as internal flow paths within a flow path formation block, and they may also be formed using tubes or pipes or the like. It is sufficient if a structure is employed that enables heat to travel, preferably via heat transfer, between the exhaust gas flowing through the first exhaust gas heat discharge flow path and the air flowing through the dilution gas flow path.

In the first embodiment, each flow path is formed so as to turn back on itself, however, it is also possible, for example, for the number of times each flow path turns back on itself to be either increased or decreased, or for straight flow paths to be formed without any turns. In addition, it is also possible for the heat absorption plates to be omitted from the second exhaust gas heat discharge flow path, and for moisture to be removed from exhaust gas by causing condensation to be generated, for example, on an inner peripheral surface of the housing. Moreover, the placements of the first exhaust gas heat discharge flow path and the second exhaust gas heat discharge flow path relative to the dilution gas flow path are not limited to the positions sandwiching the dilution gas flow path in vertical directions described in the first embodiment. For example, it is also possible for the first exhaust gas heat discharge flow path and the second exhaust gas heat discharge flow path to be disposed so as to sandwich the dilution gas flow path in horizontal directions. Furthermore, it is also possible to provide the first exhaust gas heat discharge flow path and the second exhaust gas heat discharge flow path such that they do not sandwich the dilution gas flow path, but instead to provide one flow path extending above, and in parallel with, the dilution gas flow path, and to provide the other flow path extending at a side of, and in parallel with, the dilution gas flow path. In other words, it is sufficient if a placement is employed that enables a heat exchange with the dilution gas flow path to occur in both the first exhaust gas heat discharge flow path and the second exhaust gas heat discharge flow path.

The analyzer measurement target does not necessarily include all of the various target gas components illustrated in the above-described embodiments, and may instead be just a portion of these target gas components. Moreover, it is also possible for the measurement principle of the analyzer to be appropriately selected in accordance with the target gas component.

The gas that is supplied to the dilution gas flow path is not limited to being a gas that is introduced through the base end of this flow path. For example, it is also possible for a cylinder that has been preloaded with a gas for diluting and cooling exhaust gas to be connected the base end of the dilution gas flow path, and for the gas used for dilution and cooling to be supplied from this cylinder. This type of structure as well enables the exhaust gas that has been cooled by the gas supplied from the cylinder to then be subsequently diluted. Because mounting a cylinder in a vehicle in this manner also makes it possible for both the function of cooling and the function of diluting the exhaust gas to be achieved using the gas supplied from this cylinder, it is easy to tolerate this structure being employed even if it does cause an increase in the overall weight of the exhaust gas analysis device. Moreover, the gas composition supplied to the dilution gas flow path is not limited to being air, and any other gas composition may be used provided that it causes no harm to the environment or the like when released to the outside after having diluted the exhaust gas.

In the second embodiment, no heat absorption plate is provided on the exhaust gas flow path, however, in order to make it possible for moisture to be more easily condensed from the exhaust gas, it is also possible for heat absorption plates to be provided so as to block the flow direction of the exhaust gas. Moreover, the number and diameter and the like of the exhaust gas circulation holes may be set as is appropriate.

The suctioning of the exhaust gas flowing through the exhaust gas flow path and the suctioning of the gas flowing through the dilution gas flow path may also be performed by a plurality of exhaust pumps provided independently of each other.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

### INDUSTRIAL APPLICABILITY

There is provided a vehicle-mounted drain separator that provides an improved performance when removing moisture from exhaust gas without the power consumption being increased compared to the conventional technology, and to also provide an exhaust gas analysis device that utilizes this vehicle-mounted drain separator.

### DESCRIPTION OF THE REFERENCE NUMERALS

200 . . . Exhaust Gas Analysis Device
100 . . . Drain Separator
AL . . . Dilution Gas Flow Path
EP . . . Exhaust Gas Intake Port
EL . . . Exhaust Gas Flow Path
EL1 . . . First Exhaust Gas Heat Discharge Flow Path
EL2 . . . Second Exhaust Gas Heat Discharge Flow Path
CP . . . Confluence Point
DL . . . Diluted Exhaust Gas Flow Path
1 . . . Flow Path Formation Block
CH1 . . . First Communication Hole
CH2 . . . Second Communication Hole
2 . . . Housing
3 . . . Heat Transfer Mechanism
31 . . . Partitioning Plates
CT . . . Cutout
32 . . . Heat Absorption Plates
EH . . . Exhaust Gas Circulation Holes
SL . . . Slit
4 . . . Condensation Moisture Accumulation Portion
COM . . . Information Processing Unit
P . . . Exhaust Gas Pump
X . . . Analyzer

1. A vehicle-mounted drain separator that is used in a vehicle-mounted exhaust gas analysis device, comprising:
an exhaust gas flow path through which flows exhaust gas; and
a dilution gas flow path through which flows a gas that is used to dilute exhaust gas, and that merges with the exhaust gas flow path at a confluence point provided at a downstream end portion, wherein
the vehicle-mounted drain separator is formed in such a way that a heat exchange is generated at least on an upstream side of the confluence point between the exhaust gas flowing through the exhaust gas flow path and the gas flowing through the dilution gas flow path.

2. The vehicle-mounted drain separator according to claim 1, wherein the exhaust gas flow path comprises:
a first exhaust gas heat discharge flow path into which exhaust gas is introduced from an exhaust gas intake port; and
a second exhaust gas heat discharge flow path that is provided on a downstream side of the first exhaust gas heat discharge flow path, and merges with the dilution gas flow path at the confluence point, wherein
a condensation moisture accumulation portion in which moisture that has been condensed from the exhaust gas is accumulated is provided on the second exhaust gas heat discharge flow path.

3. The vehicle-mounted drain separator according to claim 2, wherein a flow path area of the first exhaust gas heat discharge flow path is formed so as to be greater than an aperture area of the exhaust gas intake port.

4. The vehicle-mounted drain separator according to claim 2, wherein a flow path area of the second exhaust gas heat discharge flow path is formed so as to be greater than the flow path area of the first exhaust gas heat discharge flow path.

5. The vehicle-mounted drain separator according to claim 2, further comprising a heat absorption plate that is provided on either the first exhaust gas heat discharge flow path or the second exhaust gas heat discharge flow path so as to obstruct the flow direction of the exhaust gas, and in which at least one exhaust gas circulation hole is formed, and
the heat absorption plate is formed so as to transfer heat absorbed from the exhaust gas to a gas flowing through the dilution gas flow path.

6. The vehicle-mounted drain separator according to claim 5, wherein the dilution gas flow path is formed as an internal flow path inside a flow path formation block, and
the heat absorption plate is disposed so as to be in contact with the flow path absorption block.

7. The vehicle-mounted drain separator according to claim 6, wherein the first exhaust gas heat discharge flow path is formed as an internal flow path inside the flow path formation block together with the dilution gas flow path.

8. The vehicle-mounted drain separator according to claim 2, wherein the condensation moisture accumulation portion is provided in a lower portion of the second exhaust gas heat discharge flow path.

9. The vehicle-mounted drain separator according to claim 2, wherein the first exhaust gas heat discharge flow path and the second exhaust gas heat discharge flow path are disposed so as to sandwich the dilution gas flow path between them.

10. The vehicle-mounted drain separator according to claim 1, wherein a flow direction of the exhaust gas flow path or a flow direction of the dilution gas flow path is formed so as to turn back on itself at least once.

11. The vehicle-mounted drain separator according to claim 1, wherein the exhaust gas flow path and the dilution gas flow path are provided in close proximity to each other.

12. A vehicle-mounted exhaust gas analysis device comprising:
the vehicle-mounted drain separator according to claim 1; and
an analyzer that analyzes exhaust gas, wherein
a structure is employed in which exhaust gas that has passed through the analyzer is introduced into the drain separator.

13. The vehicle-mounted exhaust gas analysis device according to claim 11, wherein a diluted exhaust gas flow path through which flows exhaust gas that has been diluted by gas is provided on a downstream side of the confluence point between the exhaust gas flow path and the dilution gas flow path, and
an exhaust gas pump is provided on the diluted exhaust gas flow path.
